(19) United States
(12) Patent Application Publication
(10) Pub. No.: US 2004/0259502 A1
(43) Pub. Date: Dec. 23, 2004

(54) Method and apparatus for mitigating IM interference effects in two-way radio subscriber units

(76) Inventors: Michael N. Weidner, Plantation, FL (US); Nikhil P. Iyer, Plantation, FL (US); Kirk B. Stuart, Sunrise, FL (US)

Correspondence Address: Barbara R. Doutre, Motorola, Inc., Law Department, 8000 West Sunrise Boulevard, Fort Lauderdale, FL, 33322, US

(21) Appl. No.: 10/465,189

(22) Filed: Jun. 19, 2003

(51) Int. Cl. H04B 1/00; H04B 15/00

(52) U.S. Cl. 455/63.1; 455/550.1

(57) ABSTRACT

A system and method provides intermodulation (IM) interference mitigation in a two-way radio receiver (100) by utilizing various states of an automatic gain control circuit (AGC) (118) controlled by RSSI levels and timers.

### RELATED APPLICATION

This application is related to currently pending Ser. No. 10/331,373 (docket CM03756J_Cutcher) entitled “A System and Method for Selectively Utilizing an Attenuation Device in a Two-Way Radio Receiver Based on Squelch Detect and Radio Signal Strength Indication (RSSI)” assigned to Motorola, Inc.

### TECHNICAL FIELD

This invention relates in general to two-way radio communication systems, and more particularly to mitigating the effects of inter-modulation (IM) based interference to the receivers of such systems.

### BACKGROUND

Two-way radios are typically designed with a robust amount of gain in their front end amplifier stages. As is well known in the art, one drawback of providing too much gain occurs when multiple communications systems are operated in close proximity to one another. The radio frequency (RF) gain stages of the radio receiver can both provide gain but can also act to enhance interfering signals. Generally, the cause of this type of problem stems from intermodulation distortion (IMD) and adjacent channel interference, which degrade radio performance in the form of poor radio reception. Intermodulation distortion interference occurs from adjacent channel interference that mixes with other RF signals to produce an unwanted RF signal on or near the receiver filter pass-band. This type of interference is becoming more common every day as radio spectrum becomes more crowded with differing types of users, RF signal power levels, and modulation schemes that all attempt to fit into a finite space.

In the past, one common way to help the receiver reduce this type of interference has been through the use of an attenuator device. The attenuator is a circuit the may be inserted between the antenna of the radio receiver and the RF amplifier circuitry in order to reduce the amount of RF energy reaching the receiver. As a general rule since the intermodulation product is a third order non-linear expression, every one decibel (dB) of attenuation that is switched in circuit provides a three dB reduction in the amount of intermodulation interference in the radio receiver.

One method currently used to control an attenuator for controlling this type of interference is through the use of a radio signal strength indication (RSSI) measurement. In this method, the signal strength is typically measured at the antenna or at some point in the RF amplifier chain in order to determine the absolute signal strength of the input radio signal. The signal strength may also be mathematically computed in a digital signal processor (DSP). If the radio signal reaches some predetermined threshold, then an attenuator may be switched into the receiving circuit in order to reduce the amount of interference that might be caused by this high signal condition. In some schemes, attenuation may even be switched in a stepped fashion where a greater amount of attenuation is used depending on the level of the RF input signal. Other schemes may use the RSSI measurement in conjunction with a carrier squelch (CSQ) detector circuit or software. However, CSQ is solely dependent on the RSSI measurement and not some “known” information.

The problem associated with these types of arrangements is that the receiver cannot determine if the received RF signal is an actual signal to be received or if the high RSSI level is merely interference or a combination of both. In general, when interference is present, the RSSI level is the sum of both the desired signal power and the interference power. Since both an on-channel signal and off-channel interference will provide a high RSSI level, the attenuator will continually be left in-line. This severely reduces the sensitivity of the receiver in situations where low RSSI levels need to be received. Communications are often missed since the receiver does not receive these lesser signals in view of the attenuator that is always in circuit.

With the increasing deployment of commercial communication systems in the same band as public safety communication systems, the problem of inter-modulation based interference due to multiple strong nearby transmitters will continue to worsen. The interference will have an adverse affect on the ability of radios to meet the user's communication needs.

Accordingly, there is a need to provide an improved method and apparatus for mitigating the effects of IM interference in two-way radios.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 shows a front end line up of a radio that employs the IM protection of the present invention; and

FIG. 2 is a classification table in accordance with a preferred embodiment of the invention.

FIG. 3 shows an automatic gain control (AGC) state machine in accordance with the present invention.

FIG. 4 is an example of off-frequency sampling in accordance with FIG. 3.

FIG. 5 is a flow chart of the IM interference mitigation technique in accordance with the preferred embodiment of the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

In accordance with the present invention, there is provided herein a method for mitigating intermodulation interference and providing improved performance in IM scenarios through the use of an advanced radio frequency automatic gain control (AGC). The method allows a radio to receive the intermediate signal with improved signal quality (SINAD, BER, etc.). The method improves radio operation in both analog and digital modes on conventional and trunked channels.

The mitigation technique of the present invention is used in conjunction with discrete RF attenuators to implement radio frequency (RF) automatic gain control (AGC). The technique is predicated on the principle that the IM interfering signal is attenuated at 3 dB for every 1 dB of attenuation that is experienced by the directed signal. In accordance with the present invention, as long as sufficient signal strength is present on the desired signal, attenuators can be engaged to substantially reduce the IM interfering signal's strength relative to the desired signal.

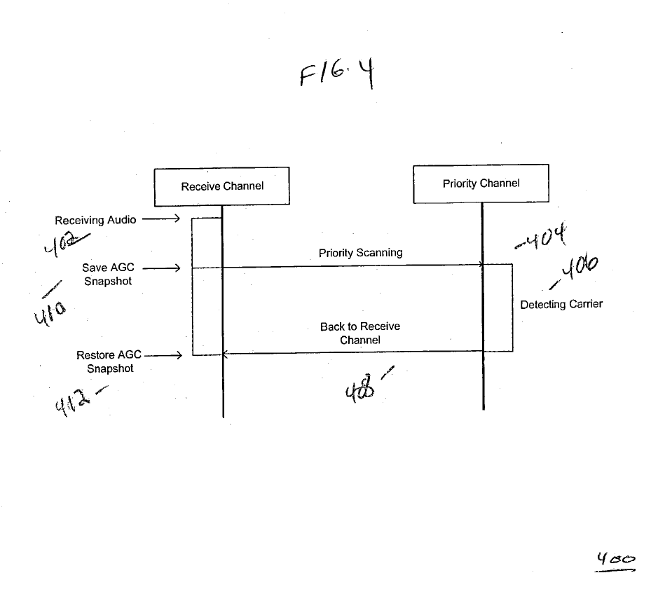

In accordance with the present invention, the AGC algorithm is centered on an event driven state machine as shown in FIG. 3. The state machine drives the attenuators based on various inputs. The algorithm is activated upon powering up the radio and it stays active during all operations of the radio.

The basic idea behind the state machine is to use RSSI as an indication of a strong signal or IM interfering condition. The AGC algorithm is provided with RSSI thresholds (stored in the radio persistent storage) that preferably qualify the signal as very weak, weak, ideal, strong, or very strong. Depending on the current RSSI value, attenuators are activated or deactivated if the RSSI is stronger that the ideal range, attenuators are turned on. Similarly, if the RSSI values are weaker than the ideal range, attenuators are turned off. Timers are used to provide filtering to reduce chatter.

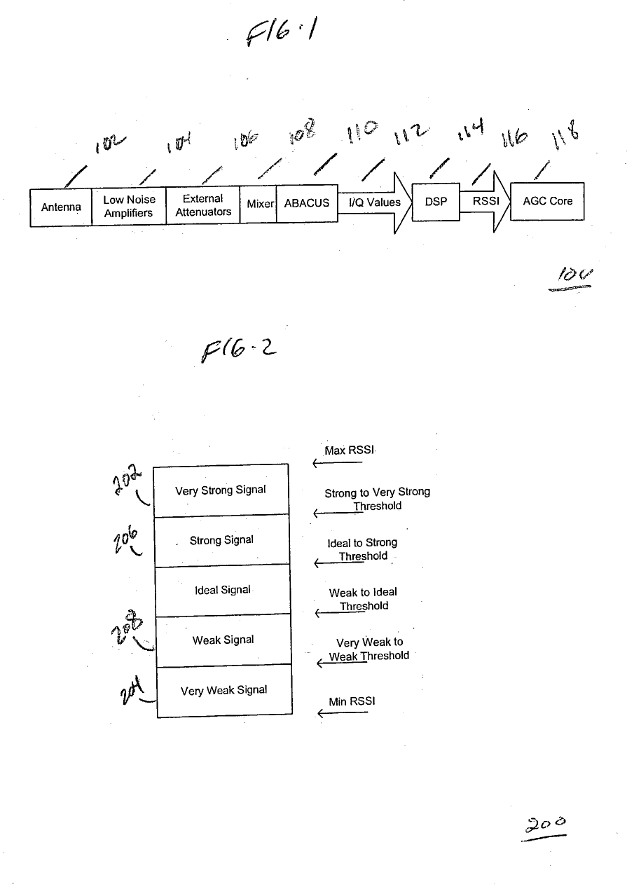

FIG. 1 shows a front end line up of a radio that employs the IM protection of the present invention. The radio front end 100 includes an antenna 102, low noise amplifiers 104, external attenuators 106, mixer 108, an ABACUS 110 providing I/Q values 112 to a digital signal processor (DSP) 114 outputting an RF signal having received signal strength indicators 116 are sent to an AGC core 118. The external attenuators 106 and the ABACUS 110 together form the components that are driven in the firmware to counter IM interference.

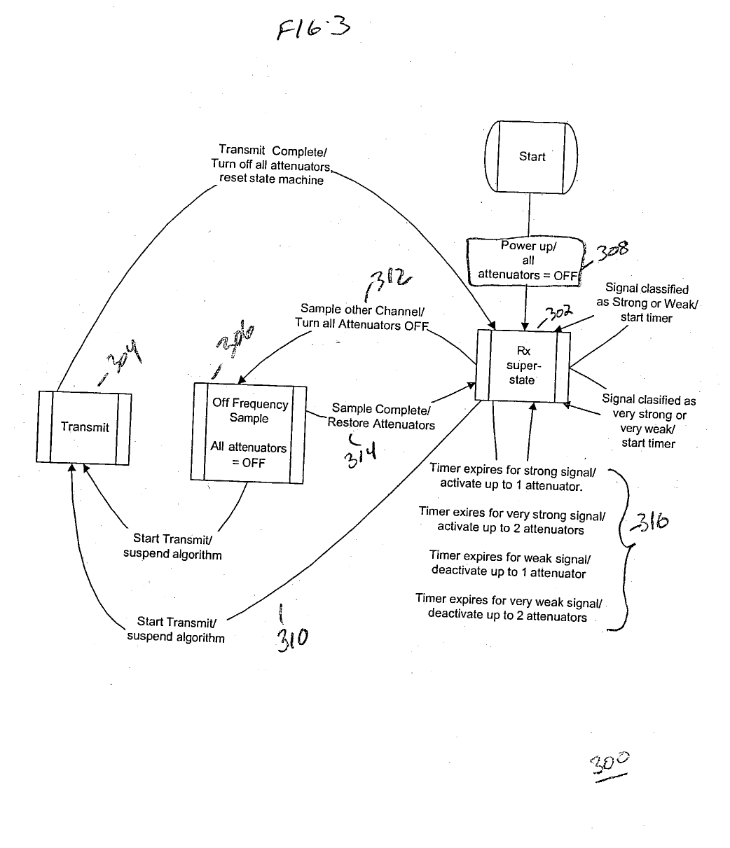

In accordance with the present invention, signals are classified into ranges based on RSSI thresholds stored in persistent storage. The signals are preferably classified as shown in FIG. 2.

Referring to both FIGS. 1 and 2 and discussing in terms of a preferred embodiment, when the signal 116 is classified as very strong 202 and remains in that classification for a predetermined amount of time, up to two attenuators 106 are applied in addition to any other attenuators that may already be active. If all available attenuators 106 are active, no action is taken. In the opposite case, where the signal 116 is classified as very weak 204 and remains in that classification for a predetermined amount of time duration, up to two attenuators are turned off. When the signal 116 is classified as strong 206 and remains in that classification for a predetermined amount of time, then one attenuator is activated. When the RSSI signal 116 is classified as weak 208 and remains in that classification for a predetermine amount of time, one attenuator is deactivated. Depending on the system more attenuators and threshold levels can be used.

FIG. 3 shows an automatic gain control (AGC) state machine 300 in accordance with the present invention. In accordance with the present invention, the AGC core (AGC core 118 of FIG. 1) has four primary states:

ON State 302

The ON state 302 is the primary operating state. The algorithm is active in this state. Attenuators may be active based on the RSSI at present. Any number of attenuators can be activated (zero through the maximum number).

Transmit (TX) State 304

When the radio is in a transmit mode 304, the algorithm is suspended. The attenuators are in a “don't care” state, i.e. they are left in the same state as they were in before entering transmit. All RSSI values are ignored until the radio enters a receive (RX) again.

Off-Frequency State 306

The AGC core is in the off-frequency state 306 state when the radio briefly goes off the current channel to sample a different frequency. Examples of this are Priority Scan and trunked control channel adjacent site sampling, and control channel hunting to name a few.

When the radio completes the off-frequency sample and returns to its original channel, the attenuator reverts back to it's previous setting provided that the radio return back within a predetermined amount of time. If too much time elapses, all the attenuators are reset 308.

Disabled State

In the disabled state, the AGC algorithm is disabled entirely. None of the attenuators are activated in this state. Debugging can be performed in the disabled state.

Various RF events are processed by the state machine 300 of the present invention:

RX to TX transition 310

When the radio enters transmit mode 304, the algorithm maintains its current state and is suspended without turning any attenuators on or off. In the transmit mode the algorithm is temporarily stopped. Any timers that the state machine may have been waiting on a re disabled in this state.

TX to RX transition 312

When the radio dekeys and enters the receive mode, the AGC algorithm is reset and restarted. As with all RF transitions, any times that may have originally been requested are stopped. The pre-personality AGC setting is passed in from the signaling function that invoked the RX change. This setting is used to program the radio.

RX to RX transition

The simplest case for a RX to RX transition is a mode change. In this case, the algorithm is simply reset and the new AGC setting for this personality is loaded.

(1) Off Frequency Sampling (RX to RX Transition) 312, 314

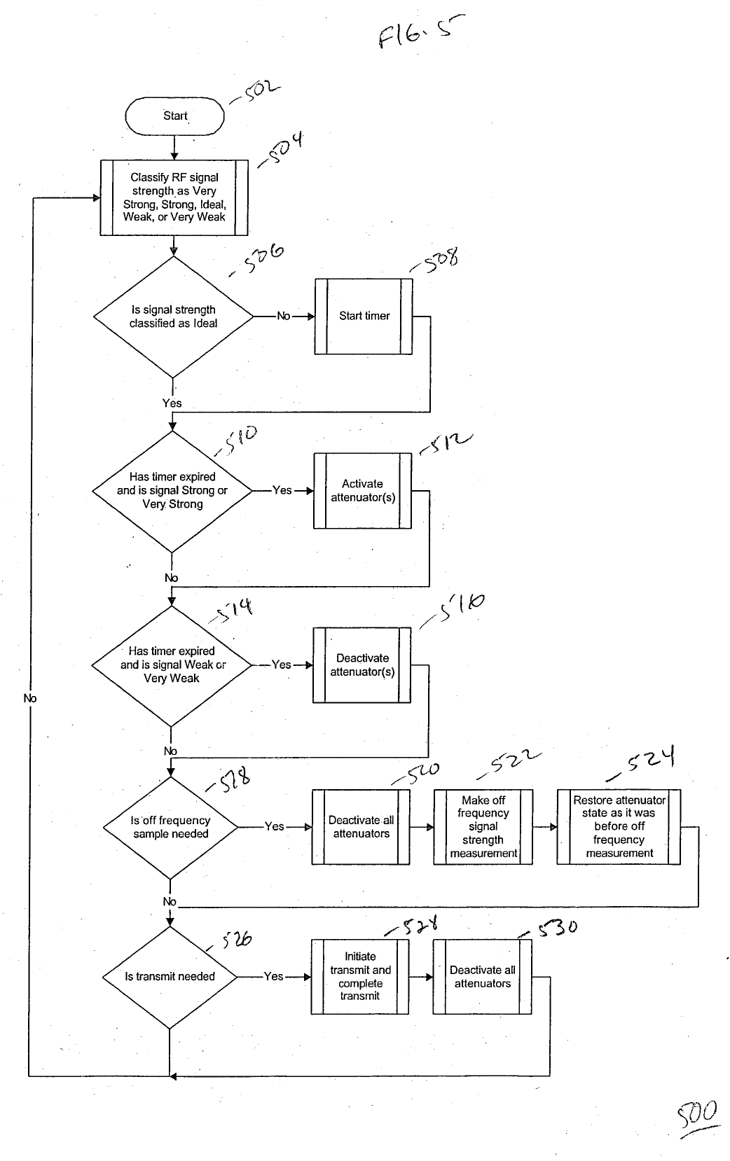

In some instances, when the radio makes a RX to RX transition, the destination may be an off-frequency channel, e.g. priority scan. FIG. 4 shows a priority-scan example of off-frequency sampling. While the radio is actively receiving 402 with priority scan turned on, the receiver goes off the current receive channel 404, checks for carrier 406 and returns back 408. In such cases, the algorithm captures a snapshot 410 of the AGC state machine. This includes the current number of active attenuators, current AGC mode, current signal strength and current state. All attenuators are then disabled and the samples are made of the off-frequency channel. If the radio returns back to the receive channel within a set period of time, the AGC algorithm restores all the state information back 412 and re-activates the attenuators that were previously active. If too much time elapses while making the off-frequency measurement(s), the algorithm gets reset. Another example of off-frequency sampling is control channel hunting that occurs periodically during trunking—the radio is in the off-frequency state during this mode.

RSSI events

The RSSI is continuously monitored and is classified into one of the predetermined RSSI classifications (e.g. very strong, strong, ideal, weak, and very weak). When the signal classification changes, the appropriate timer is started. Additional classifications can be used depending on the system requirements.

TIMER events 316

For the preferred embodiment of the invention, the following timer events are provided.

(1) Very Strong Signal Timer Expiration

When the signal is classified as very strong and remains in the classification unit the timer expires, the algorithm will activate up to two attenuators

(2) Strong Signal Timer Expiration

When the signal is classified as strong and remains in that classification until the timer expires, the algorithm will activate one attenuator

(3) When the signal is classified as weak, and remains in that classification until the timer expires, the algorithm will deactivate one attenuator

(4) Very Weak Signal timer Expiration

When the signal is classified as very weak and remains in that classification until the timer expires, the algorithm will deactivate up to two attenuators.

Referring now to FIG. 5, there is show a flowchart of the IM interference mitigation technique, previously referred to as algorithm, in accordance with the a preferred embodiment of the invention. Technique 500 starts at step 502 with receiving an RF signal and classifying the RF signal strength under a predetermined classification (very strong, strong, ideal, weak, very weak) at step 504. Step 506 determines if the signal strength is classified as ideal, if not then a timer is started at step 508 and the technique proceeds to step 510. At step 510, timer expiration is checked and the signal strength is measured to see if it is strong or very strong. If all conditions are met at step 510, then an attenuator(s) is set at step 512 and the process flow continues to step 514. At step 514, the timer is again checked for expiration and the signal is monitored to determine whether it is weak or very week. If the conditions of 514 are met, the attenuators(s) are deactivated at step 516 and the technique moves on to step 518. At step 518, a determination is made as to whether off-frequency sampling is needed. If off-frequency sampling is needed, then the flow continues to steps 520, 522, 524, where attenuators are deactivated, off-frequency signal strength is measured, and the attenuator is restored to it before off frequency state and the flow proceeds to step 526. At step 526, the technique verifies whether to enter the transmit mode and if so, initiates and completes the transmitting at step 528 prior to deactivating all the attenuators at step 530. The technique then starts afresh back at step 504. For signals that were determined to fall within an ideal signal strength classification at step 506 the technique will proceed through steps 510 and 514 but may still require off-frequency sampling and the transmit determination occurring through steps 518-530. As mentioned earlier additional RSSI classifications and additional attenuators can be used if desired.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method used in a radio receiver for mitigating IM interference in a two-way communications device, comprising the steps of:
receiving a radio frequency (RF) signal;
classifying the RF signal according to its received signal strength under a predetermined set of ideal and non-ideal classifications;
starting a timer under non-ideal received signal strength classifications;
activating an attenuator when the timer has expired and the received signal strength falls within a first predetermined non-ideal threshold; and
deactivating the attenuator when the timer has expired and the signal falls within a second predetermined non-ideal threshold.

2. The method of claim 1, further comprising:
determining whether off-frequency sampling is needed; and
determining whether a transition to a transmit mode is needed.

3. The method of claim 2, wherein the step of determining whether off-frequency sampling is needed further comprises the steps of:
deactivating an attenuator;
measuring off-frequency signal strength; and
restoring the attenuator to its previous state.

4. The method of claim 2, wherein the step of determining whether a transition to a transmit mode is needed, further comprises:
initiating and completing the transmit; and
deactivating the attenuators.

5. A method of mitigating intermodulation (IM) interference in a two-way radio receiver having a plurality of attenuators, comprising:
generating a plurality of classifications that covers very weak, weak, ideal, strong and very strong RSSI signals;
storing the classifications in persistent storage;
measuring RSSI of a received RF signal;
activating up to two attenuators when the measured RSSI is classified as very strong and remains in that classification for a predetermined amount of time;
deactivating up to two attenuators when the measured RSSI is classified as very weak and remains in that classification for a predetermined amount of time;
activating one attenuator when the RSSI is classified as strong and remains in that classification for a predetermined amount of time; and
deactivating one attenuator when the RSSI signal is classified as weak and remains in that classification for a predetermined amount of time.

6. A two-way radio, including:
an automatic gain control (AGC) circuit operating in four primary states to control IM interference through a plurality of attenuators and timers wherein the states comprise:
an ON state in which a plurality of attenuators are activated based on RSSI measurements;
a transmit (TX) state in which the plurality of attenuators are left in the same state as they were in before entering the transmit state;
an off-frequency state in which the two-way radio goes off-channel to sample a different frequency and the plurality of attenuators are turned off, when the radio completes the off-frequency sample and returns to its original channel within a predetermined amount of time, the attenuators revert back to previous settings; and
a disabled state in which the plurality of attenuators are disabled.

7. A two-way radio receiver having a front end line-up, including:
an automatic gain control (AGC) circuit; and
attenuators controlled by the AGC based on RSSI levels to provide IM interference mitigation for the two-way radio receiver.

8. The two-way radio of claim 7, further comprising:
an antenna for receiving a radio frequency (RF) signal;
a low noise amplifier;
a plurality of external attenuators;
a mixer;
an ABACUS providing I/Q signals; and
a digital signal processor (DSP) outputting a signal characterized by received signal strength indicators (RSSI).
